(19) United States
(12) Patent Application Publication
(10) Pub. No.: US 2015/0332003 A1
(43) Pub. Date: Nov. 19, 2015

(54) COMPUTER READABLE STORAGE MEDIA FOR UTILIZING DERIVED MEDICAL RECORDS AND METHODS AND SYSTEMS FOR SAME

(71) Applicant: UnitedHealth Group Incorporated, Minnetonka, MN (US)

(72) Inventors: Patrick Stamm, Fort Myers, FL (US); Alex Barclay, San Diego, CA (US); Chris Melvin, Inver Grove Heights, MN (US); Susan Hines, Hansville, WA (US)

(21) Appl. No.: 14/713,711

(22) Filed: May 15, 2015

Related U.S. Application Data
(60) Provisional application No. 62/000,287, filed on May 19, 2014.

(51) Int. Cl. G06F 19/00

(52) U.S. Cl. CPC G06F 19/328

(57) ABSTRACT

Disclosed embodiments include methods and systems for creating and utilizing derived medical records. In accordance with one or more embodiments, a derived medical record system may utilize one or more derived medical records to improve insight into patient health, identify future risk factors, and improve claim processing efficiency. In some examples, the derived medical record system may further provide derived medical records based on healthcare data stored in structured and unstructured data sources.

### TECHNICAL FIELD

Examples of the present invention relate to healthcare claims and more specifically to derived medical records.

### BACKGROUND OF THE INVENTION

Healthcare providers, such as physicians, generate large volumes of member health information during the course of business. When a patient visits a physician for the first time, for example, the physician generally creates a medical record detailing the patient's medical history, current treatments, medications, insurance and/or other pertinent information. The record generally includes the results of patient visits, including laboratory test results, the physician's diagnosis, medications prescribed and treatments administered, and over time, the physician supplements the file to maintain an updated medical record. Periodically, insurance companies request claim specific medical records from a provider as part of the claim evaluation process. However, reviewing and/or maintaining requested medical records for this purpose is often expensive and cumbersome.

### BRIEF DESCRIPTION OF THE DRAWINGS

FIG. 1 illustrates a schematic diagram of a derived medical record system in accordance with an embodiment of the invention.

FIG. 2 illustrates a schematic flow chart of a method for providing a derived medical record in accordance with an embodiment of the invention.

FIG. 3 illustrates a schematic flow chart of a method for reducing medical record request false positives in accordance with an embodiment of the invention.

FIG. 4 illustrates a schematic flow chart of a method for identifying incremental fraud and abuse in accordance with an embodiment of the invention.

FIG. 5 illustrates a schematic flow chart of a method for identifying notable member behavior in accordance with an embodiment of the invention.

FIG. 6 illustrates a schematic flow chart of a method for improving medical management in accordance with an embodiment of the invention.

### DETAILED DESCRIPTION

Overview:

Computer readable media for utilizing derived medical records and methods and systems for the same are disclosed herein. In accordance with one or more embodiments of the present invention, a derived medical record system may utilize one or more derived medical records to improve insight into patient health and to identify future risk factors. In some examples, the derived medical record system may further provide derived medical records, for instance, based on healthcare data stored in structured and unstructured data sources. Certain details are set forth below to provide a sufficient understanding of embodiments of the invention. However, it will be clear to one skilled in the art that embodiments of the invention may be practiced without various aspects of these particular details. In some instances, well-known network components, communication protocols, authentication protocols, and software operations have not been shown in detail in order to avoid unnecessarily obscuring the described embodiments of the invention.

Embodiments of the present invention are directed to derived medical records. Derived medical records may be constructed by a health plan administrator and/or information from the health plan administrator may be available to the DMR engine for providing (e.g., generating) the derived medical records. Generally, a derived medical record may be associated with a member of a health plan and comprise structured data and/or unstructured data including but not limited to an aggregation of data associated with a member's health record (e.g., plan, claims, procedures, lab tests, conditions, calls, eligibility) and provider billing history for services rendered to the member. Accordingly, a derived medical record may comprise a holistic description (e.g., profile) of a member's historical, current, and future health condition and patterns, and further may be indicative of a member's behavioral patterns and risk factors.

More specifically, in some instances, a derived medical record may be analogous to a member's medical record prepared and maintained by a physician. That is, the derived medical record may specify one or more procedures, diagnoses, conditions, health risks, or any other medical attributes associated with a member. In contrast to previous medical records, such as electronic medical records (EMRs) and personal health records (PHRs), derived medical records may include inferences about the member's health instead of merely adopting information included in a medical health record associated with the member.

Derived medical records may be updated on a periodic basis. By way of example, a claim associated with a member may be received, and based on a condition indicated by the claim and/or a policy of the member's health plan, additional medical attributes, such as expected conditions or expected future medical services, may be inferred. Inferred medical attributes or healthcare-related activities may thereafter be added to the derived medical record. In another example, a member's claim may indicate the member is obese, and although not specifically indicated by the claim, it may be inferred that the member has high blood pressure. Moreover, because the member's policy may include coverage for blood pressure medication, it may further be inferred that the member is likely to be prescribed blood pressure medication. Accordingly, the derived medical record of the member may include an inference that the member has high blood pressure and/or may be prescribed particular medication. In a further example, health plan programs in which the member is enrolled, such as a diabetes management program offered by the member's health plan (a form of unstructured data), in combination with past claims history may be used to infer future medical services expected to be received by the member, which may be added to a member's derived medical record. In yet another example, clinical guidelines combined with demographics of the member may be used to infer the member is likely to utilize healthcare services during particular times of the year, and this information may be added to the member's derived medical record, for instance, for use in designing outreach programs for the member. In this manner, structured data (e.g., claim) and/or unstructured data (e.g., policy, programs, clinical guidelines) may be used to generate a derived medical record without, for instance, use of a medical record.

Briefly, according to embodiments of the present disclosure, derived medical records may be applied in connection with adjudication of claims (e.g., medical claims). Generally, claim adjudication refers to a process by which claims are evaluated for instance, based on a comparison of the claims to a benefit, policy, or contract, and based on the evaluation, the adjudicated claims are paid or denied. During such evaluation, medical records are sometimes requested from a provider to confirm billing accuracy. By inferring about the member's health using a derived medical record instead of requesting and reviewing one or more medical records associated with the member, the number of requests for medical records may be reduced.

In a more particular example, derived medical records may be used in connection with applying prepay rules during claim adjudication. Any number of prepay rules may be applied to each claim, and may, for instance, be used to improve payment integrity by ensuring only proper claims are paid. By way of example, a prepay rule may identify one or more particular claims of a patient that depart from claims of analogous patients, and the prepay rule may “flag” the identified claims for a subsequent review (automatic or manual review) or simply reject the identified claims. As another example, a prepay rule may flag separate claims associated with a same patient and date, but different geographical locations. Prepay rules implemented by claim processing systems may be directed to a wide variety of data analysis methodologies including but not limited to static rules, statistical analyses, predictive models, and analysis of data interrelationships, and further may simultaneously consider any number of claims or any amount of data in analyzing claims. When the prepay rule criteria are met or predictive model scoring thresholds are exceeded, medical record requests are typically generated. However, by analyzing the claim in the context of the derived medical record including a member's conditions and health outlook, expected or typical medical practices may be detected in the claim making medical record review unnecessary prior to claim payment.

As described in further detail below, derived medical records may be used to compare claims to expected medical attributes. For instance, derived medical records may be generated independently from medical records, e.g., EMRs or PHRs, and may be a useful tool for comparing with medical records or claims submitted by providers to identify potential instances of fraud, waste and/or abuse. Moreover, derived medical records may be used to evaluate member behavior and health risks.

Detailed Description of the Drawings And Embodiments:

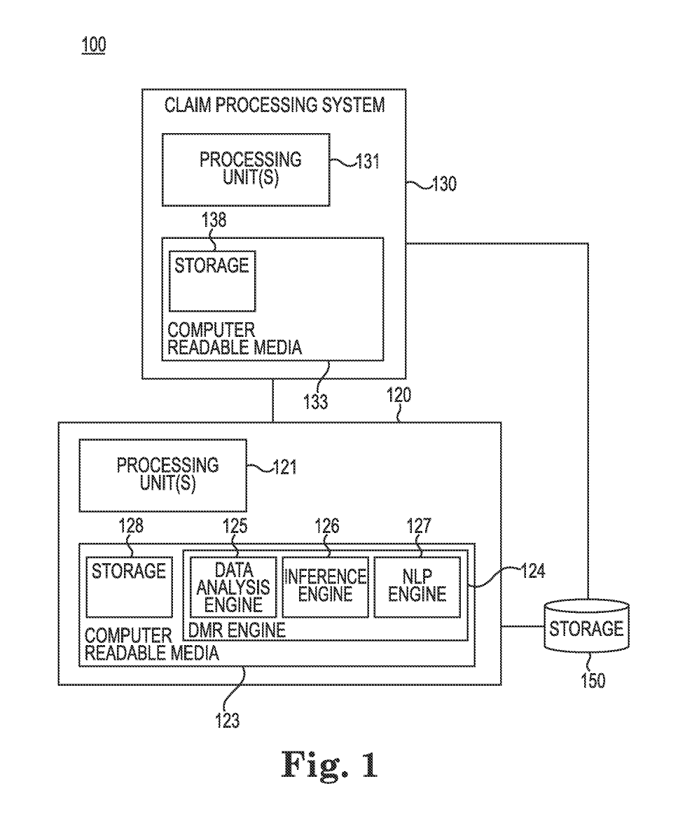

FIG. 1 illustrates a derived medical record (DMR) system 100 according to an embodiment of the invention. The DMR system 100 may include a DMR server 120, a claim processing system 130, and storage 150.

The DMR server 120 may include one or more processing units 121 and computer readable media 123. Herein, the term computer readable media is used to refer to a single computer readable medium in some embodiments, and in other embodiments multiple computer readable media in communication with one or more processing units, such as the processing units 121. The computer readable media 123 may store executable instructions for a DMR engine 124 and/or any other executable instructions. The computer readable media 123 may also include a storage 128. The executable instructions for a DMR engine 124 may include instructions for providing and/or utilizing one or more derived medical records, further examples of which are provided below. In particular, the DMR engine 124 may include instructions for a data analysis engine 125, an inference engine 126, and a natural language processing (NLP) engine 127.

Although the executable instructions for the DMR engine 124, including the instructions for the data analysis engine 125, the inference engine 126, and the NLP engine 127, are shown on a same computer readable media 123, in some embodiments any or all sets of instructions may be provided on multiple computer readable media and may not be resident on the same media. Accordingly, computer readable media 123 as used herein includes one or more computer readable media 123. Computer readable media 123 and/or storage 128 may include any form of computer readable storage or computer readable memory, transitory or non-transitory, including but not limited to externally or internally attached hard disk drives, solid-state storage (such as NAND flash or NOR flash media), tiered storage solutions, storage area networks, network attached storage, and/or optical storage.

As described, the instructions stored on the computer readable media 123 may be executed on the one or more processing units 121 or other processing units. The executable instructions for a DMR engine 124 may be referred to as a “DMR engine” herein, where the DMR engine refers to the executable instructions for a DMR engine 124 executed by the one or more of the processing units 121 or other processing units. The executable instructions for a data analysis engine 125 may be referred to as a “data analysis engine” herein, where the data analysis engine refers to the executable instructions for a data analysis engine 125 executed by the one or more of the processing units 121 or other processing units. The executable instructions for an inference engine 126 may be referred to as an “inference engine” herein, where the inference engine refers to the executable instructions for an inference engine 126 executed by the one or more of the processing units 121 or other processing units. The executable instructions for a NLP engine 127 may be referred to as a “NLP engine” herein, where the NLP engine refers to the executable instructions for a NLP engine 127 executed by the one or more of the processing units 121 or other processing units.

The claim processing system 130 may process claims for payment as will be understood by those of skill in the art and may include one or more processing units 131 and computer readable media 133. The computer readable media 133 may also include a storage 138.

The storage 150 may be accessible to the DMR engine 124, data analysis engine 125, inference engine 126 and/or the NLP engine 127, and claim processing system 130 for storing data and/or accessing data stored therein. In some examples, the storage 150 may be configured to store any form and/or type of data, such as healthcare data. By way of example, the storage 150 may be configured to store claims data including but not limited to data associated with diagnoses, disease progression, acute/chronic conditions, procedures, locations of service, cause codes, provider specialties, hospitalizations, lifestyle factors, and frequency of care. In another example, the storage 150 may be configured to store provider data including but not limited to data associated with provider billing, patient types, patient provider choices, specializations, record submissions, practice patient profiles, and accreditation. In yet another example, the storage 150 may be configured to store records data including but not limited to data associated with labs, images, pre-authorizations, screening results, self-reported items, helpdesk calls, and HSA balances. In yet another example, the storage 150 may be configured to store member policies (e.g., health plans), eligibility data including but not limited to data associated with marital status, gender, distance from services, family structure, language, employment, family (may be linked to claims for medical history), health-related programs in which the member is enrolled, and health-related programs for which the member is targeted. In yet another example, the storage 150 may be configured to store pharmaceutical data including but not limited to data associated with medications, compliance, and allergies. In yet another example, the storage 150 may be configured to store demographic data including but not limited to data associated with life expectancy, housing types, community, income, ethnicity, and diet. In yet another example, the storage 150 may be configured to store epidemiological data including but not limited to data associated with disease progression and life expectancy. In yet another example, the storage 150 may be configured to store social media data including but not limited to data associated with religious and/or community support, fitness activities, and interests. In yet another example, the storage 150 may be configured to store credit score data including but not limited to data associated with spending behaviors, risks, finances, and past medical expenses. In yet another example, the storage 150 may be configured to store coding data including but not limited to data associated with related conditions and rules for code use. In yet another example, the storage 150 may be configured to store insurance record data including but not limited to data associated with payer claims and hospitalizations, including those related to third parties.

The storage 150 may comprise any data storage known in the art, now or in the future, including externally or internally attached hard disk drives, solid-state storage (such as NAND flash or NOR flash media), tiered storage solutions, storage area networks, network attached storage, and/or optical storage. In some examples, the storage 150 may be configured to communicate with the DMR server 120 over one or more networks, such as local area networks (LANs), wide area networks (WANs), metropolitan area networks (MANs), cellular networks, and/or the Internet. Communications provided to and from the storage 150 may wired and/or wireless, and further may be provided using any networking devices known in the art, now or in the future. In other examples, the storage 150 may be included in the DMR server 120. Moreover, while the storage 150 is shown as comprising a single storage, in some embodiments any or all data of the storage 150 may be provided on multiple storages 150. Accordingly, storage 150 may comprise any number of storages 150 located within the DMR server 120 and/or communicatively coupled thereto.

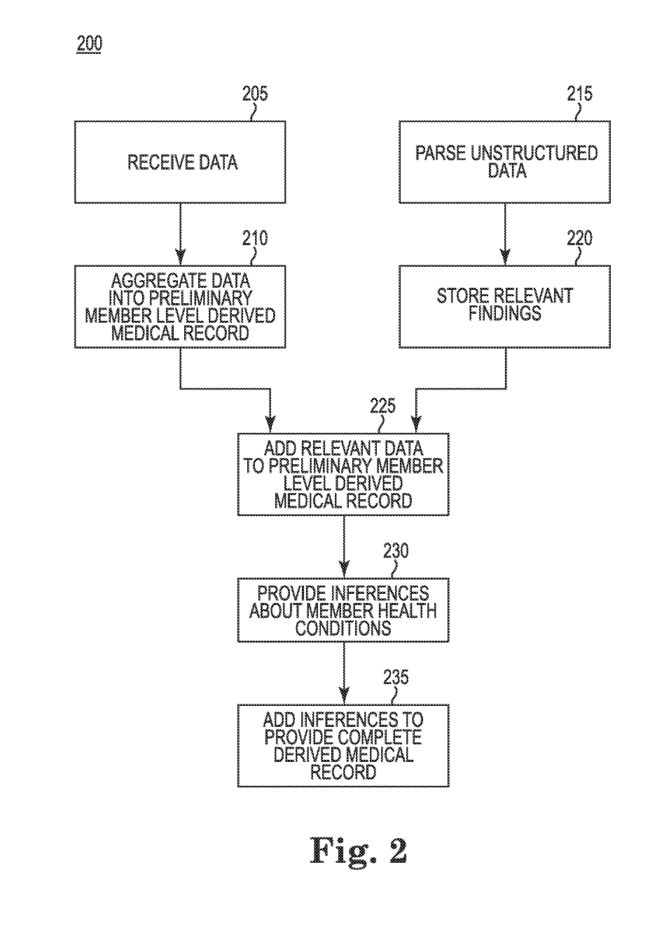

FIG. 2 illustrates a schematic flow chart of a method 200 for providing a derived medical record in accordance with an embodiment of the invention. The method 200 may, for example, be implemented by the DMR server 120 of FIG. 1, and in particular by data analysis engine, inference engine, and NLP engine. At a step 205, the data analysis engine may receive data, for instance, from the storage 150. Data received in this manner may be associated with a particular member and include claim data (e.g., claim history), provider data (e.g., provider associations), other member data (e.g., demographic data), or combinations thereof. Additionally or alternatively, the data analysis engine may parse data received from third party data sources. Data received by the data analysis engine may typically be structured, and in some examples, the data analysis engine may parse the storage 150 to select which data the data analysis engine will receive at the step 205. In this manner, the data analysis engine may selectively optimize the amount of data received.

At a step 210, the data analysis engine may aggregate one or more portions of the received data. By way of example, the data analysis engine may aggregate data, such as data directed to procedures, diagnoses, providers, dates of patient visits by the member, and frequency of patient visits by the member, for instance, into one or more data structures, to provide a preliminary member level derived medical record. The preliminary member level derived medical record may be stored in the storage 128 and/or the storage 150.

At a step 215, the NLP engine may interpret unstructured data, for instance, located on the storage 150. By way of example, the NLP engine may interpret the unstructured data to identify relevant healthcare data associated with the member included in free-textual data sources, such as medical notes, contracts, member policies, and clinical guidelines. Additionally or alternatively, the NLP engine may interpret data received from third party data sources. In some examples, the NLP engine may interpret the unstructured data using a natural language processing algorithm and/or graphing analytics. At a step 220, the NLP engine may store any relevant healthcare data identified while interpreting the unstructured data at the step 215. The relevant healthcare data may, for instance, be stored in the storage 128 and/or the storage 150.

In some examples, the data analysis engine and the NLP engine may perform one or more respective steps simultaneously, concurrently, or in any otherwise overlapping manner. By way of example, the data analysis engine may perform step 205 while the NLP engine performs step 215. In other examples, the data analysis engine may perform the steps 205, 210 prior to the NLP engine performing the steps 215, 220, or may perform the steps 205, 210 after the NLP engine performs the steps 215, 220.

At a step 225, the NLP engine may add the identified relevant healthcare data to the preliminary member level derived medical record to provide an intermediate member level derived medical record. The intermediate member level derived medical records may be stored in the storage 128 and/or the storage 150.

At a step 230, the inference engine may analyze the intermediate member level derived medical record and/or data generated or extracted in steps 205, 210 or 215 to provide one or more inferences about the health conditions of the member and/or information that could appear on a PHR or EHR. By way of example, the inference engine may infer that a member is in good health or that a member likely has one or more conditions, for instance, based on one or more claims associated with the member. At a step 230, inferences made by the inference engine may be added to the intermediate member level derived medical record to provide a complete member level derived medical record. The complete member level derived medical record may be used in one or more applications described herein, such as those described with respect to methods 300, 400, 500, and 600, described herein, or may be used for any other purpose.

As described, in some examples, the derived medical record for a member may be based on structured data and/or unstructured data and further, may be provided without accessing provider requested medical records for the member.

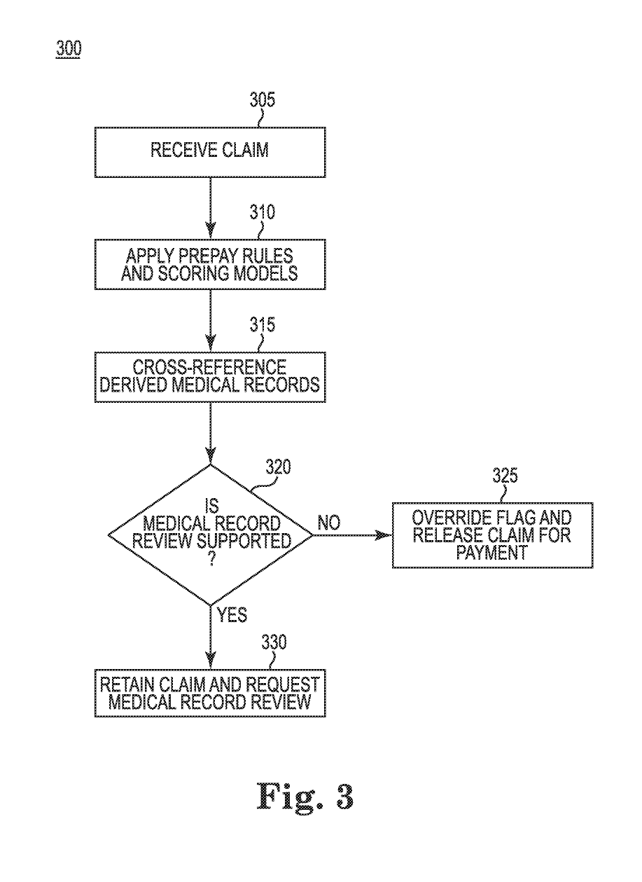

FIG. 3 illustrates a schematic flow chart of a method 300 for reducing medical record request false positives in accordance with an embodiment of the invention. The method 300 may, for example, be implemented by the system 100. At a step 305, the claim processing system 130 receives a new claim (e.g., medical claim). The claim may be received, for instance, from the storage 150.

At a step 310, the claim processing system 130 may apply one or more prepay rules and/or claim scoring models to the claim, for instance, to flag the claim. Flagging a claim in this manner may indicate that a request for a medical record review of the claim is recommended. In accordance with implementations of the present disclosure, prior to initiating a medical record review request, the DMR engine may determine if the medical record request is appropriate.

Accordingly, at a step 315, the DMR engine may cross-reference one or more derived medical records, and at a step 320, may assess whether a request for a medical record review is supported based on the cross-referenced derived medical records. Briefly, a request for a medical record may be supported by the derived medical records when, in light of cross-referencing the one or more derived medical records, the DMR engine determines that a request for a medical record review of the flagged claim is still recommended as determined by the prepay rules and/or scoring algorithms applied at step 310.

If the DMR engine determines that the derived medical records do not support the request for a medical record review, at a step 325, the DMR engine may override the flag applied to the claim at step 310 and release the claim for payment. If the DMR engine determines that the derived medical records do support the request for a medical record review, at a step 330, the DMR engine may retain the flag so that a medical record is requested to facilitate further review of the claim. In some examples, retaining the flag in this manner may include storing the claim in a particular portion of the storage 128, may include adding an entry associated with the claim to a data structure (e.g., list), or combinations thereof. Further review of the claim may include automatic and/or manual review of the claim.

With respect to method 300, in some instances, benefits available to a member under his or her respective health plan may drive member engagement in his or her healthcare. As another example, campaigns under a health plan directed to the member may result in the member closing a gap in their care. The derived medical record may include information about the rationale behind the member's behavior in engaging in his or her healthcare or closing gaps in care based on their health plan and associated programs offered to the member. In these examples, where a claim is flagged for medical record review after application of prepay rules in step 310, cross-referencing with the member's derived medical record, as described with respect to step 315, may result in an inference that the member's behavior, in light of the information about the member's plan and campaigns directed to the member, is consistent with acceptable practices and a determination may be made at step 320 that a medical record review is unsupported, thereby allowing the process to flow to step 325 where the flag for medical claim review may be overridden and the claim may be released for payment.

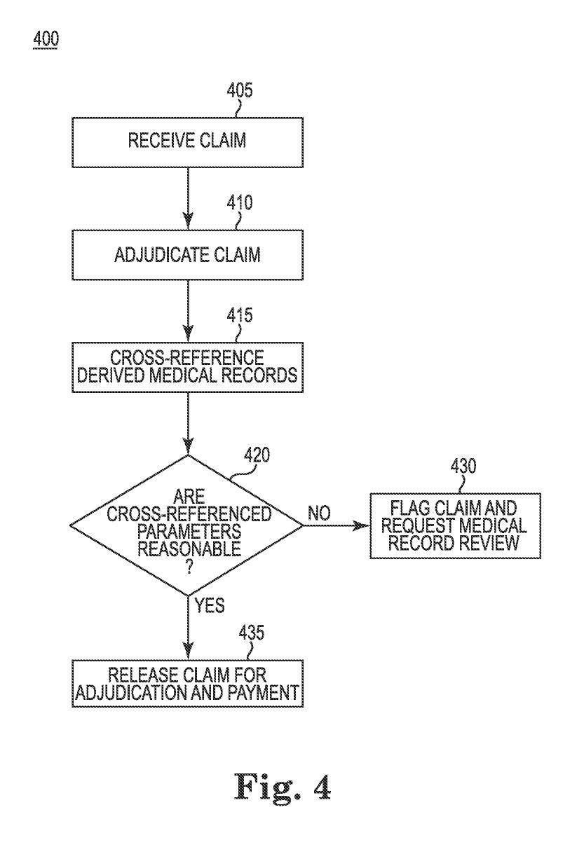

FIG. 4 illustrates a schematic flow chart of a method 400 for identifying incremental fraud and abuse in accordance with an embodiment of the invention. The method 400 may, for example, be implemented by system 100. At a step 405, the claim processing system 130 receives a new claim. The claim may be received, for instance, from the storage 150. In some examples, the received claim may be scored and/or evaluated using one or more prepay rules prior to being received by the DMR server 120.

At a step 410, the claim adjudication begins, for instance, at the claim processing system 130. As described, adjudicating a claim may include automatically and/or manually determining whether a claim should be paid or denied based on a comparison of the claim to a benefit or scope of coverage. Prior to completion of the adjudication, however, at a step 415, the DMR engine may be called upon to cross-reference one or more parameters (e.g., diagnoses, procedures, codes) of the claim with derived medical records to determine whether a medical record request is needed. By way of example, the DMR engine may compare one or more services associated with the claim to inferred member conditions as indicated by the derived medical records. In another example, the DMR engine may compare codes and/or procedures to expected codes and/or procedures and/or provider billing as indicated by the derived medical records. At a step 420, the DMR engine may determine whether the cross-referenced parameters associated with the claim are reasonable. The DMR engine may, for instance, determine whether the parameters of the claim exceed one or more thresholds and/or whether particular parameters, such as medical codes, match expected parameters indicated by the derived medical records.

If the DMR engine determines that the parameters are not reasonable, at a step 430, the DMR engine may flag the claim for a medical record request to facilitate further review of the claim, as previously described. If the DMR engine determines that the parameters are reasonable, at a step 435, the DMR engine may release the claim for additional adjudication steps and payment, for instance, by the claim processing system 130.

As described, a derived medical record may include inferences, for instance, about a provider's rationale for diagnosing and/or treating a member. For example, where the provider submits a pre-authorization for running tests that were previously performed on a member, the derived medical record may include a record of the provider's request for pre-authorization from the health plan administrator as well as information on the previously performed tests, and an inference may be generated that the provider requesting pre-authorization has knowledge of the previously run tests. In this example, cross-referencing claims for the tests with a member's DMR, as described with respect to step 415, may result in determining the provider is requesting a re-test as opposed to the provider engaging in waste or abuse, and the DMR engine may determine that the tests performed were reasonable, as described with respect to step 420, and the claim may be released for adjudication and payment, as described with respect to step 435.

While the methods 300 and 400 have been described with respect to a single claim, in some examples, multiple instances of the methods 300 and 400 may be implemented at a same time such that multiple claims may be considered simultaneously, concurrently, or in any otherwise overlapping manner. Moreover, in some examples, each of the methods 300, 400 may be implemented on a same claim simultaneously, concurrently, or in any otherwise overlapping manner, respectively.

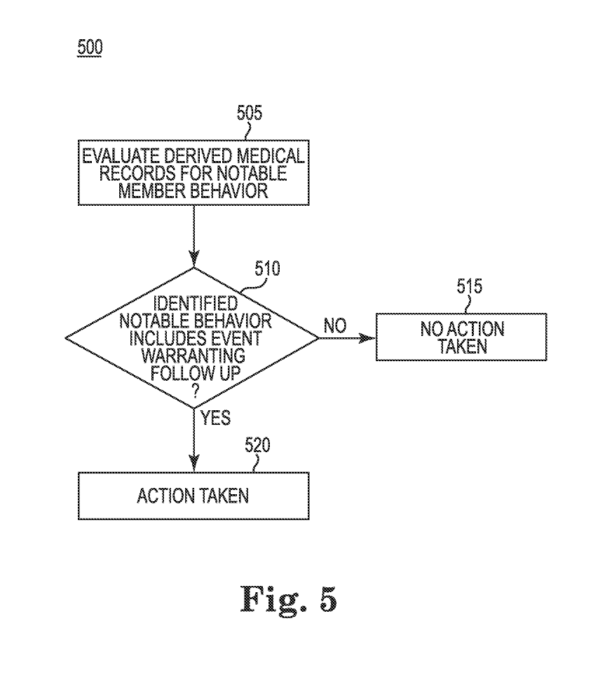

FIG. 5 illustrates a schematic flow chart of a method 500 for identifying notable member behavior in accordance with an embodiment of the invention. The method 500 may, for example, be implemented by the DMR server 120 of FIG. 1, and in particular by the DMR engine of the DMR server 120. At a step 505, the DMR engine may evaluate one or more derived medical records to identify any notable (e.g., abnormal) member behavior. Evaluating derived medical records in this manner may, for instance, include evaluating one or more derived medical records located on the storage 150 and/or the storage 128.

At a step 510, the DMR engine may determine whether, in response to evaluating the one or more derived medical records, any of the identified notable behavior includes an event wherein a follow up with a member is recommended. Such events may be identified with respect to the member's previous behavior and/or with respect to the previous behavior of other members. An example event may, for instance, include deviation of a member's routine of prescription fulfillment. In some examples, the DMR engine may determine that a follow up is recommended based on identifying a specific sequence of events and/or may determine a follow up is recommended in response to identifying an event a particular number of times. By way of example, the DMR engine may identify an event signifying that 1,000 or more members have failed to properly follow a schedule for prescription of a specific drug.

If the DMR engine determines that no event exists such that a follow up is recommended, the DMR engine may take no further action at a step 515. Conversely, if the DMR engine identifies one or more such events, the DMR engine may take action. By way of example, the DMR engine may cause a letter, pamphlet, e-mail, or any other communication to be provided to the member and/or cause a provider to contact the member as a follow up. In this manner, the DMR engine may ensure that the member is informed of any risks associated with his or her behavior (e.g., improper prescription use) and encourage correct behavior of the member. In some examples, the action taken by the DMR engine may be based specifically on an identified event. Accordingly, actions taken by the DMR may be tailored to specific member behaviors.

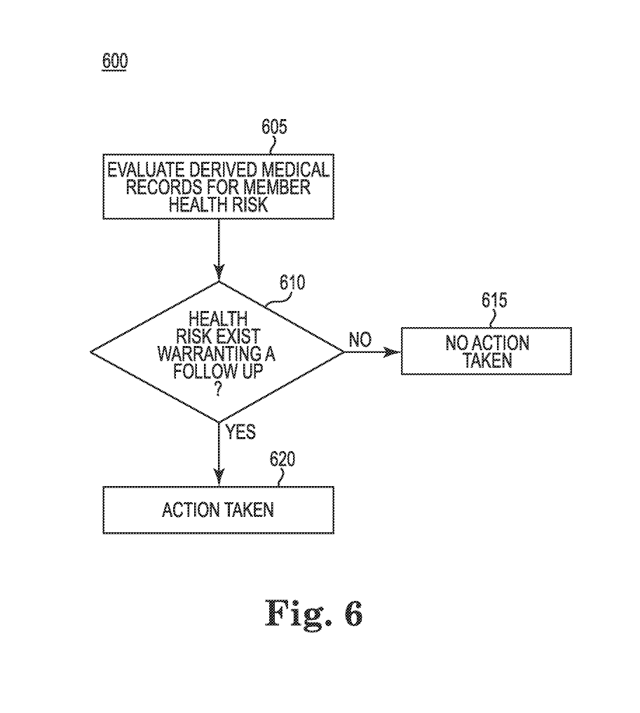

FIG. 6 illustrates a schematic flow chart of a method 600 for improving medical management in accordance with an embodiment of the invention. The method 600 may, for example, be implemented by the DMR server 120 of FIG. 1, and in particular by the DMR engine of the DMR server 120. At a step 605, the DMR engine may evaluate one or more derived medical records to determine whether member health risk may be inferred. Member health risk may be inferred, for instance, based on any number of factors including but not limited to behavior, conditions, and procedures associated with the member. In some examples, evaluating derived medical records may, for instance, include evaluating one or more derived medical records located on the storage 150 and/or the storage 128.

At a step 610, the DMR engine may determine whether, in response to evaluating the one or more derived medical records, one or more health risks exist such that a follow up with a member is recommended. Such events may be identified with respect to the member's medical history and/or with respect to the medical history of other members. An example event may, for instance, include a member being identified as a smoker. In some examples, the DMR engine may determine that a follow up is recommended based on identifying a specific plurality of factors indicating one or more particular health risks and/or may determine a follow up is recommended in response to identifying an event a particular number of times. By way of example, the DMR engine may identify an event signifying that 1,000 or more members have been identified as smokers.

If the DMR engine determines that no event exists such that a follow up is recommended, the DMR engine may take no further action at a step 615. Conversely, if the DMR engine identifies one or more such events, the DMR engine may take action. As described, the DMR engine may cause a letter, pamphlet, e-mail, or any other communication to be provided to the member and/or cause a provider to contact the member as a follow up. In this manner, the DMR engine may ensure that the member is informed of the identified risks (e.g., risks associated with smoking) and suggest remedial measures the member may consider to mitigate the identified risks. In some examples, the action taken by the DMR engine may be based specifically on an identified event. Accordingly, actions taken by the DMR may be tailored to specific member behaviors.

While description has been made herein with respect to each of the methods 500, 600 being implemented in a single instance, in some examples, the DMR engine may be configured to perform one or more of the methods 500, 600 periodically. In this manner the DMR engine may regularly evaluate whether events warranting a follow up exist.

According to exemplary embodiments, apparatuses, systems, computer-implemented methods, and computer-readable media having instructions stored thereon may cause a processor to perform steps for generating derived medical records and for using the derived medical records for improving the accuracy and/or preciseness of detecting fraud, waste and/or abuse. The steps may involve receiving a new claim for a member under a health plan; analyzing the adjudicating claim using pre-payment rules; assigning a score to the adjudicating claim indicative of whether the adjudicating claim relates to an instance of one or more of fraud, waste or abuse; determining the score assigned to the adjudicating claim is above a threshold; analyzing the adjudicating claim against a derived medical record for the member, wherein analyzing compares inferences in the derived medical record having been generated at least by evaluating a claims history of the member against the health plan of the member; determining whether the analysis supports the score assigned to the adjudicating claim; where the analysis does not support the score assigned to the adjudicating claim, routing the adjudicating claim for finalization and payment; and updating the derived medical record using a finalized claim generated from the adjudicating claim.

Aspects of the present disclosure may result in the efficient detection of fraud, waste and/or abuse. Using derived medical records, systems may automatically apply inferences contained in these records to member claims, which may result in more efficient allocation of resources between claims storage systems and DMR engines, which may be housed in a claim adjudication engine. For instance, where DMR engine analyses detect a provider billing anomaly related to a member claim, the DMR engine may cause the member and provider submitting the claim to be flagged and the system may allocate memory and processing resources for analysis of historical claims of the member as well as claims submitted by the provider associated with the flagged claim to enable the DMR engine to analyze the claims against respective member derived medical records for fraud, waste and/or abuse. Analysis of flagged member and provider activities using derived medical records using dedicated resources may facilitate more quickly determining whether the member, provider or both, may be engaging in suspicious activities. Further, where the analysis removes the member or provider from consideration for fraud, waste and abuse, requests for medical records and specialized review of such records may become unnecessary or more infrequent.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A computer-implemented method for improving the accuracy of detecting medical claim fraud, waste and abuse, the method comprising the steps of:
receiving member data for a member under a health plan;
generating a preliminary derived medical record by aggregating the member data;
identifying relevant healthcare data in free text data of the member data by integrating the free text data using a natural language processing engine;
generating an intermediate derived medical record by merging the identified relevant healthcare data with the preliminary derived medical record;
providing an inference by analyzing the intermediate derived medical record;
generating the complete derived medical record by merging the inference with the intermediate derived medical record;
receiving a new adjudicating claim for the member;
analyzing the adjudicating claim using pre-payment rules;
assigning a score to the adjudicating claim indicative of whether the adjudicating claim relates to an instance of one or more of fraud, waste or abuse;
determining that the score assigned to the adjudicating claim passes a threshold;
analyzing the adjudicating claim against the complete derived medical record, by comparing inferences in the complete derived medical record, the inferences generated at least by evaluating a claims history of the member against a health plan of the member;
determining whether the analysis supports the score assigned to the adjudicating claim;
routing the adjudicating claim for finalization and payment responsive to determining that the analysis does not support the score assigned to the adjudicating claim; and
updating the complete derived medical record using a finalized claim generated from the adjudicating claim.

2. The method of claim 1, further comprising the step of, responsive to determining that the analysis does not support the score assigned to the adjudicating claim
causing the member and the provider to be flagged; and
allocating memory and processing resources for analysis of historical claims of the member and claims submitted by the provider associated with the flagged claim to enable derived medical record analysis of the claims against respective member derived medical records for fraud, waste and/or abuse.

3. A method for generating a derived medical record of a member, the method comprising:
receiving member data;
generating a preliminary derived medical record by aggregating the member data;
identifying relevant healthcare data in free text data of the member data by integrating the free text data using a natural language processing engine;
generating an intermediate derived medical record by merging the identified relevant healthcare data with the preliminary derived medical record;
providing an inference by analyzing the intermediate derived medical record; and
generating the complete derived medical record by merging the inference with the intermediate derived medical record.

4. The method of claim 3, wherein the inference was not originally present in the member data.

5. The method of claim 3, wherein the inference is that the member is in good health.

6. The method of claim 3, wherein the member data is selected from the group consisting of: claim data, claim history, provider data, provider associations, and demographic data.

7. The method of claim 3, wherein the member data is directed to one or more of: procedures, diagnoses, providers, dates of patient visits by the member or frequency of patient visits by the member.

8. The method of claim 3, wherein a data analysis engine parses storage to select the member data to be received.

9. The method of claim 3, wherein the complete derived medical record is generated without accessing provider-requested medical records for the member.

10. The method of claim 3, further comprising:
receiving a medical claim having a medical record review flag;
determining whether the medical record review flag is supported based on the complete derived medical record; and
removing the medical record review flag responsive to determining that the request for medical record review is not supported.

11. The method of claim 10, wherein determining whether the medical record review flag is supported comprises cross-referencing the medical claim with the complete derived medical record, and applying prepay rules and/or scoring algorithms to the claim.

12. The method of claim 10, wherein the complete derived medical record comprises information about a rationale behind a behavior of the member and an inference that the behavior of the member is consistent with acceptable practices.

13. The method of claim 3, further comprising:
receiving a medical claim to be adjudicated;
prior to completing adjudication of the medical claim, cross-referencing a parameter of the medical claim with the complete derived medical record;
determining whether the cross-referenced parameter is reasonable;
flagging the medical claim for medical record review responsive to determining that the cross-referenced parameter is not reasonable; and
releasing the medical claim for adjudication and payment responsive to determining that the cross-referenced parameters are reasonable.

14. The method of claim 13, wherein the medical claim comprises a pre-authorization request from a provider for running tests that were previously performed on the member;
wherein the complete derived medical record comprises information on the previously performed test; and
wherein the method further comprises:
generating an inference that the provider has knowledge of the previously run test; and
releasing the medical claim for adjudication and payment.

15. The method of claim 13, wherein determining whether the cross-referenced parameter is reasonable comprises determining whether the parameter passes a threshold and/or whether the parameter matches an expected parameter indicated by the complete derived medical record.

16. The method of claim 3, further comprising:
evaluating the complete derived medical record to identify notable member behavior; and
taking an action responsive to determining that the notable member behavior includes an event wherein a follow up with the member is recommended.

17. The method of claim 3, further comprising:
evaluating the complete derived medical record to determine whether an inferred health risk exists; and
taking an action responsive to determining that the inferred health risk exists.

18. The method of claim 17, wherein taking an action comprises:
informing the member of the inferred health risk by causing communication to be provided to the member; and
suggesting remedial measures that the member may consider to mitigate the inferred health risk.

19. A derived medical record system comprising:
a derived medical record server, comprising instructions that, when executed, cause a processing unit to:
receive member data;
generate a preliminary derived medical record by aggregating the member data;
identify relevant healthcare data in free text data of the member data by integrating the free text data using natural language processing;
generate an intermediate derived medical record by merging the identified relevant healthcare data with the preliminary derived medical record;
provide an inference by analyzing the intermediate derived medical record; and
generate a complete derived medical record by merging the inference with the intermediate derived medical record.

20. The system of claim 19, further comprising a claim processing system communicatively coupled to the derived medical record server and configured to cooperate with the derived medical record server to cross-reference a derived medical record associated with a received medical claim.
